(19) United States
(12) Patent Application Publication
(10) Pub. No.: US 2023/0342512 A1
(43) Pub. Date: Oct. 26, 2023

(54) AUTOMOTIVE SHAPE DESIGN BY COMBINING COMPUTATIONAL FLUID DYNAMICS AND GENERATIVE ADVERSARIAL NETWORKS

(71) Applicant: Ford Global Technologies, LLC, Dearborn, MI (US)

(72) Inventors: Kaushik Balakrishnan, Fremont, CA (US); Devesh Upadhyay, Canton, MI (US); Herbert Alexander Morriss-Andrews, Canton, MI (US); Ryan Joseph Madden, Royal Oak, MI (US); Suzhou Huang, Ann Arbor, MI (US); Dimitar Petrov Filev, Novi, MI (US)

(73) Assignee: Ford Global Technologies, LLC, Dearborn, MI (US)

(21) Appl. No.: 17/660,127

(22) Filed: Apr. 21, 2022

(51) Int. Cl. G06F 30/15; G06F 30/27; G06F 30/28

(52) U.S. Cl. CPC G06F 30/15; G06F 30/27; G06F 30/28

(57) ABSTRACT

Systems and methods for automotive shape design by combining computational fluid dynamics (CFD) and Generative Adversarial Network (GAN). CFD simulations may be performed to determine aerodynamic properties and identify a set of candidate vehicle outline shapes. Vehicle shape outlines may be provided as input to a generative adversarial network (GAN) that is trained to learn aesthetic preferences for vehicle attributes. The GAN may be used to determine, by based on the vehicle outline shape, a set of vehicle attributes. The GAN may be used to generate photo-realistic images with the vehicle shape outline and filling in additional aesthetic styles for the given outline, such as different colors, lighting, visual appearance, wheel design, aspect ratio, etc.

### BACKGROUND

Automotive shape design is a challenging problem as it involves the confluence of several different fields of study. For example, automotive shape design may involve both engineering and aesthetic considerations. This necessitates a multi-disciplinary approach to undertake the design and development of next-generation cars. For instance, Computational Fluid Dynamics (CFD) is used in the aerodynamic shape optimization to lower the aerodynamic drag coefficient of automobiles so that the shape of the vehicle is streamlined. This allows improved energy usage—whether it is fuel consumption for diesel/gasoline vehicles or battery usage for electric vehicles—since the aerodynamic drag is reduced. Likewise, the aesthetic style of cars is also critical as it has a better selling value to the customer. For instance, a sporty car shape appeals to younger customers, whereas a sedan has a better appeal to another cross section of customers; or a pick-up truck has appeal to yet another customer cross-section. A vehicle with the best performance-related aerodynamic shape may not meet the aesthetic expectations of a customer. Likewise, a vehicle that appeals to the customer in appearance may not have an aerodynamic shape that has a low drag coefficient. It is thus warranted to combine aerodynamics and aesthetics into the design process so that one can design automobiles with the best of both approaches.

Traditionally, cars are designed by different groups of engineers with different aspects addressed by the different groups of designers. For instance, CFD engineers optimize the external shape of cars to satisfy lower drag requirements. In parallel, body silhouette design engineers address the aesthetic/style looks of the car once the shape is finalized. This separation of two different aspects of car design is not desired as the car with the best aerodynamic shape need not have the best appeal to the customer, and vice versa. Accordingly, there is a need to improve the field of automotive or industrial shape design.

### BRIEF DESCRIPTION OF THE DRAWINGS

A detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a diagram in which Computational Fluid Dynamics (CFD) techniques may be practiced, according to at least one embodiment.

FIG. 2 illustrates a diagram in which Generative Adversarial Network (GAN) techniques may be practiced, according to at least one embodiment.

FIG. 3 illustrates a diagram of a generative adversarial network (GAN) architecture, according to at least one embodiment of the present disclosure.

FIG. 4 depicts a diagram of a pareto frontier that can be constructed to identify an optimum shape, according to at least one embodiment.

FIG. 5 depicts an illustrative flowchart of a design process, according to at least one embodiment of the present disclosure.

FIG. 6 shows an illustrative example of a process for multidisciplinary vehicle design, in accordance with one or more example embodiments of the present disclosure.

FIG. 7 shows an illustrative example of a process for multidisciplinary vehicle design, in accordance with one or more example embodiments of the present disclosure.

FIG. 8 illustrates a block diagram of an example of a machine or system upon which any one or more of the techniques (e.g., methodologies) discussed herein may be performed.

### DETAILED DESCRIPTION

### Overview

The present disclosure is directed to systems and methods for industrial shape design. Industrial shape design may cover the design of various parts for automobiles, airplanes, and more. While various embodiments described in greater detail below will reference automotive shape design, it should be understood that such techniques may be applicable to other types of designs, including but not limited to airplane shape design, drone shape design, and other such industrial contexts.

Traditionally, cars have been designed by different groups of engineers with different aspects addressed by the different groups of designers. For instance, Computational Fluid Dynamics (CFD) engineers optimize the external shape of cars to satisfy lower drag requirements. In parallel, body silhouette design engineers may address the aesthetic/style looks of the car once the shape is finalized. This separation of two different aspects of car design is not ideal as the car with the best aerodynamic shape need not have the best appeal to the customer, and vice versa. Techniques described herein below may be used to address such different design aspects by combining both aerodynamic and aesthetic considerations.

In a first embodiment contemplated within the scope of this disclosure, Computational Fluid Dynamics (CFD) is used a priori to obtain a set of candidate shapes of the car that have low aerodynamic drag coefficients. They are then provided as inputs to a pre-trained conditional Generative Adversarial Network (GAN) to output photo-realistic images of cars with high customer appeal and aesthetic styles for the optimized shape. In addition, the GAN may also involve the use of different input latent noise vectors to produce different photo-realistic images of styles, given the CFD-optimized shape. These additional input parameters may be used to provide the user with photo-realistic images where the wheel designs, car shapes aspect ratio, etc., can be customized.

In a second embodiment contemplated within the scope of this disclosure, the process described above is effectively reversed—a pre-trained Generative Adversarial Network (GAN) is used to output vehicle shapes with aesthetic styles, wheel designs, car shapes, aspect ratios, etc. that are inferred to have a high aesthetic appeal to customers. The output silhouette shapes are fed into a Computational Fluid Dynamics (CFD) solver to estimate the aerodynamic drag coefficient. Drag coefficients may be computed for the candidate shapes, and only those shapes that have a drag coefficient below a certain threshold value are progressed to the next step of the design and development process.

Accordingly, by combining the use of Computational Fluid Dynamics (CFD) and Generative Adversarial Network (GAN) techniques, a discovery environment may be implemented that allows the exploration of a large design space for the selection of an optimal design that satisfies multiple competing objectives, such as aerodynamic and aesthetic considerations.

### Illustrative Embodiments

In at least one embodiment, multi-disciplinary systems and methods are devised for the design of the next-generation automobiles, airplanes, etc. that combine Computational Fluid Dynamics (CFD) and computer vision. The overall methodology comprises a two-step process, according to at least one embodiment.

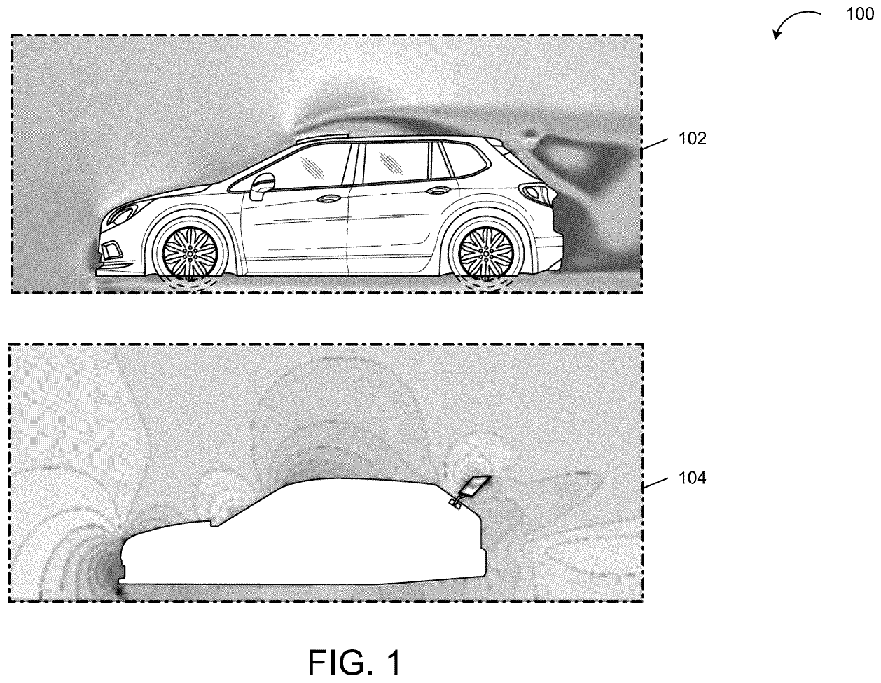

FIG. 1 illustrates a diagram 100 in which Computational Fluid Dynamics (CFD) techniques may be practiced, according to at least one embodiment. In at least one embodiment, at a first step of an automobile shape design process, different exterior side-view car shapes are considered. The different shapes may be modifications of existing car shapes and use CFD to obtain the aerodynamic drag coefficients from simulation. These different shapes may be referred to as “candidate shapes” and may refer to specific parts of an automobile, the automobile as a whole, etc. The Reynolds Averaged Navier-Stokes (RANS) CFD simulations 102 are undertaken to obtain the aerodynamic flow-field around a given candidate shape 104 at different flow speeds, and from this, an aerodynamic drag coefficient can be evaluated for each such shape. For example, different shapes and sizes for the shark fin on the vehicle can be considered to optimize the aerodynamic drag. As another example, external sensors on the vehicle (e.g., Lidar, cameras, etc.) may be encased in aerodynamically-streamlined casing so that the aerodynamic drag is minimized, and CFD can be used to obtain the optimal aerodynamic shapes for such casings. Further, performance parameters can be extracted. These may include energy usage as a function of vehicle load and speed, road grade, ambient conditions, etc. to provide performance labels to a given shape.

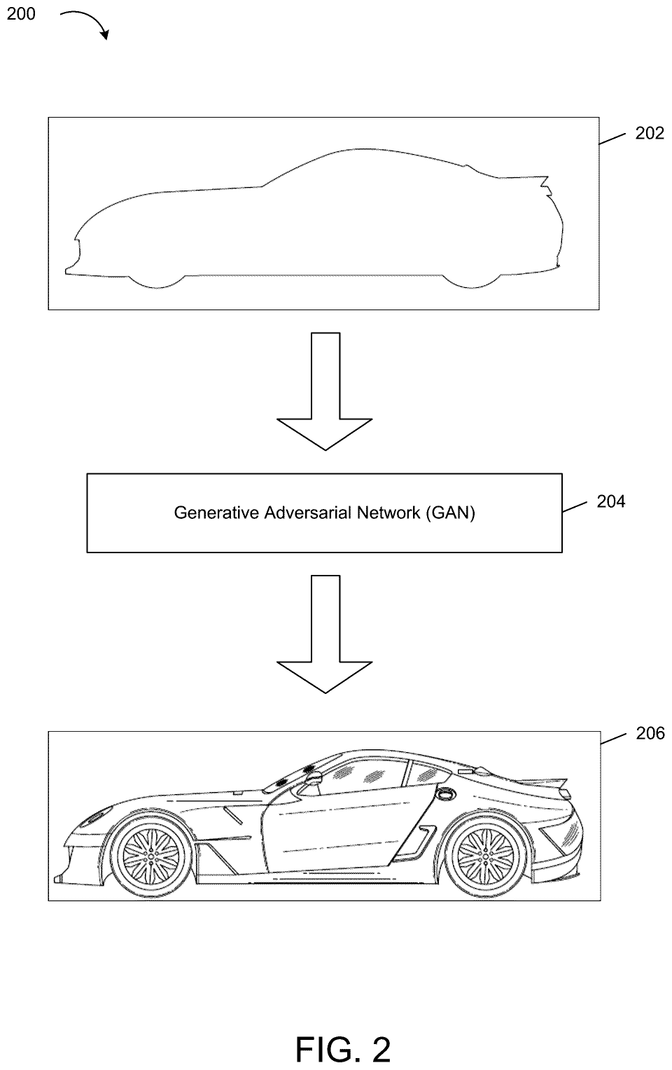

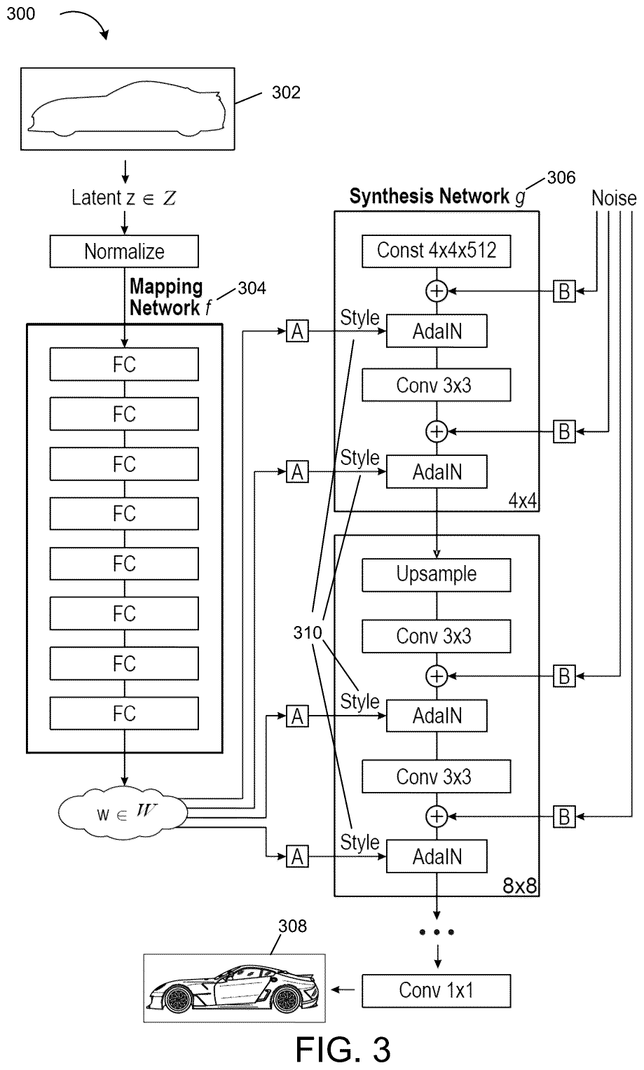

FIG. 2 illustrates a diagram 200 in which Generative Adversarial Network (GAN) techniques may be practiced, according to at least one embodiment. In at least one embodiment, an automobile's outline shape is obtained at a first step (e.g., using CFD), and at a second step of an automobile shape design process, the outline shape is provided as an input 202 to a pre-trained Generative Adversarial Network (GAN). The pre-trained GAN 204 may receive a set of input parameters comprising at least a shape outline, such as the outline of a car shape that has been determined during the first step to have certain advantageous aerodynamic properties. The output 206 of the GAN may be a set of output parameters produced by the GAN that correspond to different aesthetic styles for the given shape, such as different colors, lighting, visual appearance, wheel design, aspect ratio, etc., all of which are constructed from the input exterior shape. For example, GANs described herein may be implemented using a StyleGAN-based model, as described in “A Style-Based Generator Architecture for Generative Adversarial Networks” by T. Karras, S. Laine and T. Aila (https://arxiv.org/abs/1812.04948), which is hereby incorporated by reference in its entirety. In this GAN setting, one can add desired exterior styles to give the car an aesthetic appeal that can interest a potential customer. A GAN may be trained on images of several different cars of various manufacturers and models, from a corpus of data collected from a number of resources. The input to the GAN is an image of a car shape outline (e.g., exterior silhouette shape of the car) that is already aerodynamically optimized (as described above in the first step) and the output is different aesthetic styles for the given shape, such as different colors, lighting, visual appearance, wheel design, aspect ratio, etc., all of which are constructed from the input exterior shape. In various embodiments, a user is able to specify an input of a random real number latent noise vector to the GAN. These inputs may correspond to the design parameters of the vehicle, whose values will produce different contrasts in the colors, lighting, visual appearance, etc. in the output image. Accordingly, in the first step, CFD simulations and analysis ensure that certain candidate shapes are aerodynamically-optimized and the GAN processes these candidate shapes to improve the style and visual appearance of the car. For different noise vectors that are input to the GAN, one can obtain different colors, lightings, styles, etc., thereby providing a diversity of cars for the given input outline shape of the car. The architecture of an illustrative GAN-based neural network is depicted in FIG. 3.

It should be noted that the terms “first step” and “second step” as described above are not intended to imply or require a specific order in which different steps of an automobile shape design process are performed. For example, the second step may be performed prior to the first step, or the first step may be performed prior to the second step. It should be appreciated that such relative terms are meant merely to organizationally describe different steps of an automobile shape design process and not to enforce a specific ordering of such different steps, unless clear from context.

FIG. 3 illustrates a diagram 300 of a generative adversarial network (GAN) architecture, according to at least one embodiment of the present disclosure.

A GAN architecture utilized in the context of various embodiments may be designed in a way that exposes novel ways to control the image synthesis process. StyleGAN-based network described herein may start from a learned constant input and adjusts the “style” of the image at each convolution layer based on the latent code, therefore directly controlling the strength of image features at different scales. Combined with noise injected directly into the network, this architectural change leads to automatic, unsupervised separation of high-level attributes from stochastic variation in the generated images, and enables intuitive scale-specific mixing and interpolation operations. A vehicle outline shape 302 may be provided as an input to the GAN model.

With reference to FIG. 3, given a latent code z in the input latent space Z, a non-linear mapping network f: Z→W produces w∈W. The mapping network 304 may comprise a series of fully connected layers, for example, an 8-layer linear mapping network. In various embodiments, the dimensionality of both spaces is set to the same value (e.g., 512) and the mapping f is implemented using a MLP. Learned affine transformations specialize w to styles y=(yₛ, y_{b}) that control adaptive instance normalization (AdaIN) operations after each convolution layer of the synthesis network g. As depicted in FIG. 3, styles 310 may be provided to control AdaIN operations after each convolution layer of the synthesis network g. In at least one embodiment, AdaIN operation of synthesis network 306 is defined as:

$$AdaIN ( {x}_{i} , y ) = {y}_{s , i} \frac{{x}_{i} - μ ( {x}_{i} )}{σ ( {x}_{i} )} + {y}_{b , i}$$

where each feature map xᵢ is normalized separately, and then scaled and biased using the corresponding scalar components from style y. Thus the dimensionality of y is twice the number of feature maps on that layer.

Finally, the generator is provided with a direct means to generate stochastic detail by introducing explicit noise inputs. In various embodiments, these are introduced as single-channel images of uncorrelated Gaussian noise, and a dedicated noise image is fed to some or all layers of the synthesis network. The noise image is broadcasted to all feature maps using learned per-feature scaling factors and then added to the output of the corresponding convolution, as illustrated in FIG. 3.

As depicted in FIG. 3, and according to at least one embodiment, “A” stands for a learned affine transformation, and “B” applies learned per-channel scaling factors to each of the noise inputs. The mapping network f may refer to an 8-layer network and the synthesis layer may comprise 18 layers—two for each resolution (4²-1024²). The output of the last layer may be converted to a photo-realistic image 308 using a separate 1×1 convolution.

In at least one embodiment, a GAN is trained from a data corpus, one can feed-in the CFD-generated, aerodynamic shape-optimized, car exterior outline shapes as input to the trained GAN, and obtain the filled-in car images with diverse styles. By choosing different random latent noise vectors, one can obtain different car colors, lighting conditions, wheel designs, and other attributes. Thus, at the end of the two-step process, one obtains car images whose shapes are not only aerodynamically shape-optimized, but also have aesthetic and/or stylish appeal to a potential customer. This joint methodology is a useful design tool in the development of the next-generation automobiles.

Alternative embodiments may be implemented as well. For example, in at least one other embodiment, the above two steps are reversed: that is, the GAN is first used to add styles to a corpus of car silhouette shapes, and a subset of the shapes that have an aesthetic appeal to the design engineers are short-listed for the CFD simulations in the second step. For example, a shortlist of the top 10, 20, 30, 40, 50, 100, etc. shapes may be identified by the GAN. Here, RANS simulations are undertaken and the shortlisted shapes that have the lowest aerodynamic drag coefficients are progressed to the next step in the design process.

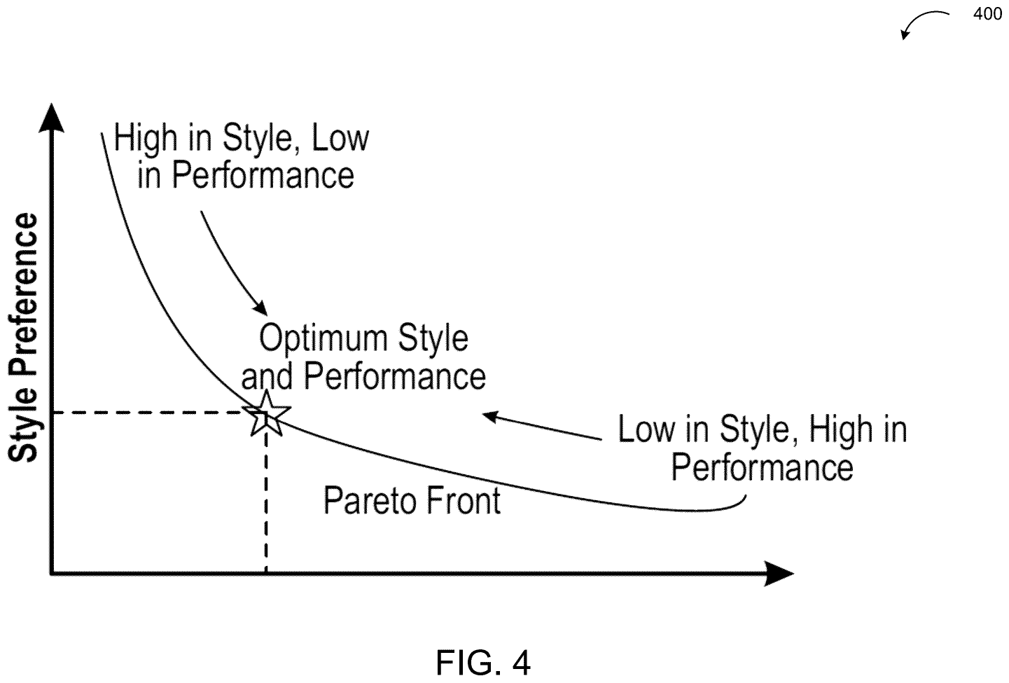

FIG. 4 depicts a diagram 400 of a pareto frontier that can be constructed to identify an optimum shape, according to at least one embodiment. A pareto frontier that can be constructed, wherein for each of candidate car shape, the aesthetic style can be quantified using subject matter expert (SME) rules and plotted along with the CFD drag coefficient. FIG. 4 illustrates a hypothetical Pareto front where some candidate shapes have high style preferences, but low in the performance metric (e.g., high drag coefficient). Likewise, at the other extreme, some shapes can be high on performance (e.g., low drag coefficient), but have a low aesthetic appeal, which is also not desired. From the Pareto front, one can identify the optimum style and performance metric (shown as the star in FIG. 4). Optimum shapes may be identified through performance of a multi-objective optimization (MOO) process. A few candidates near the optimum can be selected and one can build prototypes of these car shapes. These prototype vehicles can be experimentally tested for performance and the aerodynamic predictions of the CFD model can be verified. The models can be refined iteratively and the whole process repeated again from scratch, as needed and/or as appropriate. The overall inter-disciplinary design process may be made more robust in the described manner. Post-production, one can also further update both style and performance models as new data is made available, which can help inform the design of later generations of vehicles.

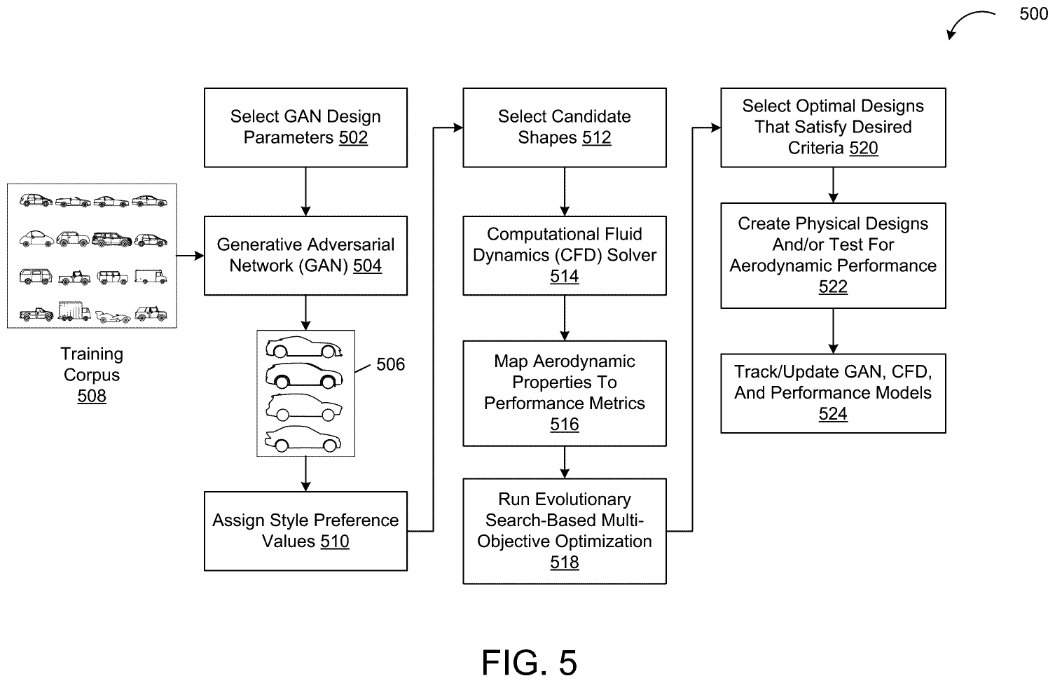

FIG. 5 depicts an illustrative flowchart 500 of a design process, according to at least one embodiment of the present disclosure. The flowchart 500 depicts the use of Computational Fluid Dynamics (CFD) and Generative Adversarial Network (GAN) to perform multi-objective optimization (MOO) and identify suitable designs that satisfy both aerodynamic and aesthetic considerations.

In at least one embodiment, flowchart 500 depicts a step to select GAN design parameters 502. GAN design parameters may refer to inputs that are provided to a Generative Adversarial Network (GAN) such as a StyleGAN-based model that is trained to generate vehicle outline shapes from the design parameters. For example, a designer may select a parameter for a vehicle class such as sedan, SUV, etc. as a design parameter. In some embodiments, the design parameters can be used to specify various aspects of the shape to be designed. The design parameters may specify that the outline should include a shark fin for the vehicle, the location and/or height of the bumper, or other information that would otherwise specify one or more design constraints on the vehicle outline shapes that the GAN is being used to generate.

In at least one embodiment, flowchart 500 depicts a step to use generative adversarial network (GAN) 504 to generate a set of vehicle outline shapes 506. The vehicle shape outlines may be generated using a pre-trained network that learns how to produce the specified vehicle outline shapes from a training corpus 508 of vehicle images. For example, images of existing vehicles may be captured and stored for later use as the training corpus 508 to train a GAN. The GAN may be a Style-GAN based model. The GAN 504 may be implemented according to any suitable architecture, such as those described in connection with FIG. 3

In at least one embodiment, vehicle shape outlines 506 refer to the outlines of vehicles or other industrial applications. For example, the GAN may be used to generate shape outlines for various car parts rather than the vehicle as a whole, or may be used in other contexts, such as for airplane design or other industrial parts or applications that may be subject to multidisciplinary considerations including but not limited to aerodynamic considerations and aesthetic considerations. In various embodiments, GAN 504 generates a fixed number of outlines that can be specified by a user. For example, the user may specify to generate 5, 10, 15, 20, etc. different outlines based on a given set of design parameters.

In various embodiments, flowchart 500 comprises a step to assign style preference values 510. The style preferences for various shape outlines may be quantified using subject matter expert (SME) rules that are encoded in an evaluation function. The scores may be in any suitable range or denomination. The scores may be from 0 to 1, 0 to 10, 0 to 100, and so forth. In at least one embodiment, flowchart 500 comprises a step to select candidate shapes 512. In various embodiments, the set of vehicle outline shapes 506 are assigned style preference values and ranked or filtered based on their respective scores. In some embodiments, vehicle outline shapes with poor style preference values may be discarded. For example, vehicle outline shapes that fall below a certain threshold or are not within the top N scores may be discarded from consideration as candidates in downstream steps of flowchart 500.

In at least one embodiment, flowchart 500 comprises a step to use a Computational Fluid Dynamics (CFD) 514 to determine aerodynamic properties of the candidate shapes. For example, a set of candidate vehicle outline shapes may be selected and then CFD simulations may be used to determine the aerodynamic drag coefficients and so forth. In various embodiments, flowchart 500 comprises a step to map aerodynamic properties to performance metrics 516. For example, performance metrics (e.g., high drag coefficient) may be determined to determine an overall performance score of a vehicle outline shape that accounts for any and/or all simulated aerodynamic properties of the outline shape. This may involve the computation of a single value that encapsulates multiple simulated aerodynamic properties of the shape that may be determined by one of skill in the art.

In at least one embodiment, performance values and style values may be determined for each of the candidate shapes. In some embodiments, a Pareto front is explored by computing pairs of performance scores and style scores for each of the candidate shapes and determining an optimal or best design outline that accounts for desirable aerodynamics and desirable aesthetics. Optimum shapes may be identified by running an evolutionary search-based multi-objective optimization (MOO) process 518. For example, the performance and aesthetic scores may be normalized to a 1-to-10 scale and the aerodynamic and aesthetic values may be multiplied together to determine a score for MOO purposes. A few candidates near the optimum can be selected and one can build prototypes of these car shapes that satisfy the desired criteria 520. The desired criteria may be determined based on aerodynamic and/or aesthetic considerations, or any other suitable criteria for selection of vehicle design. Flowchart 500 depicts a step to create physical designs and/or test for aerodynamic performance 522. The physical design may be created based on the vehicle attributes and/or vehicle shape outline determined in previous steps. The aerodynamic performance of the physical designs may be measured to determine whether the expected aerodynamic properties matches the actual measured aerodynamic properties. In various embodiments, the flowchart 500 includes a step to track and/or update the GAN, CFD, performance models, or any combination thereof. A feedback mechanism may be used to iteratively refine various aspects of the flowchart 500.

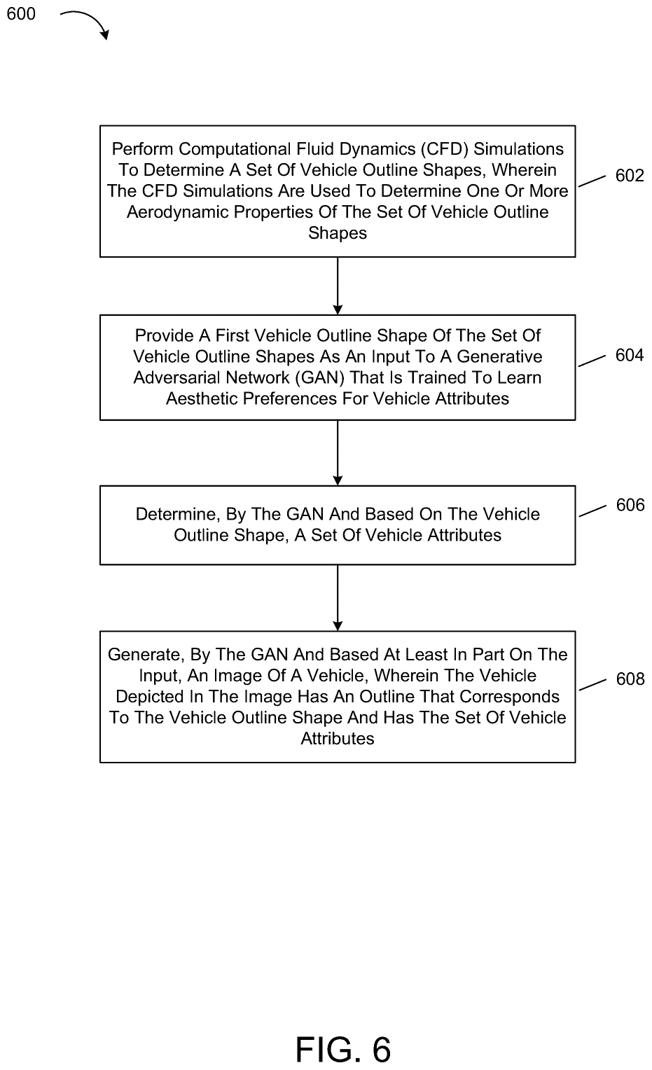

FIG. 6 shows an illustrative example of a process 600 for multidisciplinary vehicle design, in accordance with one or more example embodiments of the present disclosure. In at least one embodiment, some or all of the process 600 (or any other processes described herein, or variations and/or combinations thereof) is performed under the control of one or more computer systems that store computer-executable instructions and may be implemented as code (e.g., computer-executable instructions, one or more computer programs, or one or more applications) executing collectively on one or more processors, by hardware, software, or combinations thereof. The code, in at least one embodiment, is stored on a computer-readable storage medium in the form of a computer program comprising a plurality of computer-readable instructions executable by one or more processors. The computer-readable storage medium, in at least one embodiment, is a non-transitory computer-readable medium. In at least one embodiment, at least some of the computer-readable instructions usable to perform the process 600 are not stored solely using transitory signals (e.g., a propagating transient electric or electromagnetic transmission). A non-transitory computer-readable medium does not necessarily include non-transitory data storage circuitry (e.g., buffers, caches, and queues) within transceivers of transitory signals. Process 600 may be implemented in the context of various systems and methods described elsewhere in this disclosure, such as those discussed in connection with FIGS. 1-5. In at least one embodiment, process 600 or a portion thereof is collectively implemented by a computer system.

In various embodiments, process 600 comprises a step to perform computational fluid dynamics (CFD) simulations to determine a set of vehicle outline shapes, wherein the CFD simulations are used to determine one or more aerodynamic properties of the set of vehicle outline shapes 602. In various embodiments, CDF simulations are used to determine various performance metrics of a proposed outline. In some embodiments, the set of vehicle outline shapes are selected based on aerodynamic drag coefficient determined by the CFD simulations. For example, the top N shapes may be selected as candidates, where N=1, 2, 3, 4, 5, 10, 15, 20, and various other suitable values. The number N may be a user-selectable configuration option.

In various embodiments, process 600 comprises a step to provide a first vehicle outline shape of the set of vehicle outline shapes as an input to a generative adversarial network (GAN) that is trained to learn aesthetic preferences for vehicle attributes 604. In various embodiments, set of vehicle attributes comprises at least: color, shape, and wheel design. In various embodiment, the GAN is further configured to receive a latent code as the input, in a first latent space, determine, based on a non-linear mapping network, an intermediate vector, in a second latent space, and provide the intermediate vector as an input to one or more affine transformations of a synthesis network that synthesizes an image based on the aesthetic preferences. The GAN may comprise a non-linear mapping network of 5-10 fully connected layers. Each layer of the synthesis network may be operable to receive per-channel scaling factors for Gaussian noise inputs. The GAN may comprise a synthesis network of 15-20 layers. The GAN may be a StyleGAN-based model.

In various embodiments, process 600 comprises a step to determine, by the GAN and based on the vehicle outline shape, a set of vehicle attributes 606. In various embodiments, set of vehicle attributes comprises at least: color, shape, and wheel design. The vehicle attributes may be represented in an image that is generated by the GAN.

In various embodiments, process 600 comprises a step to generate, by the GAN and based at least in part on the input, an image of a vehicle, wherein the vehicle depicted in the image has an outline that corresponds to the vehicle outline shape and has the set of vehicle attributes 608. In various embodiments, the system preforming process 600 is further configured to determine, for each respective vehicle outline shape of the set of vehicle outline shapes, a respective performance score and a respective style score, and determine a Pareto front based on the performance scores and the styles scores of the set of vehicle outline shapes.

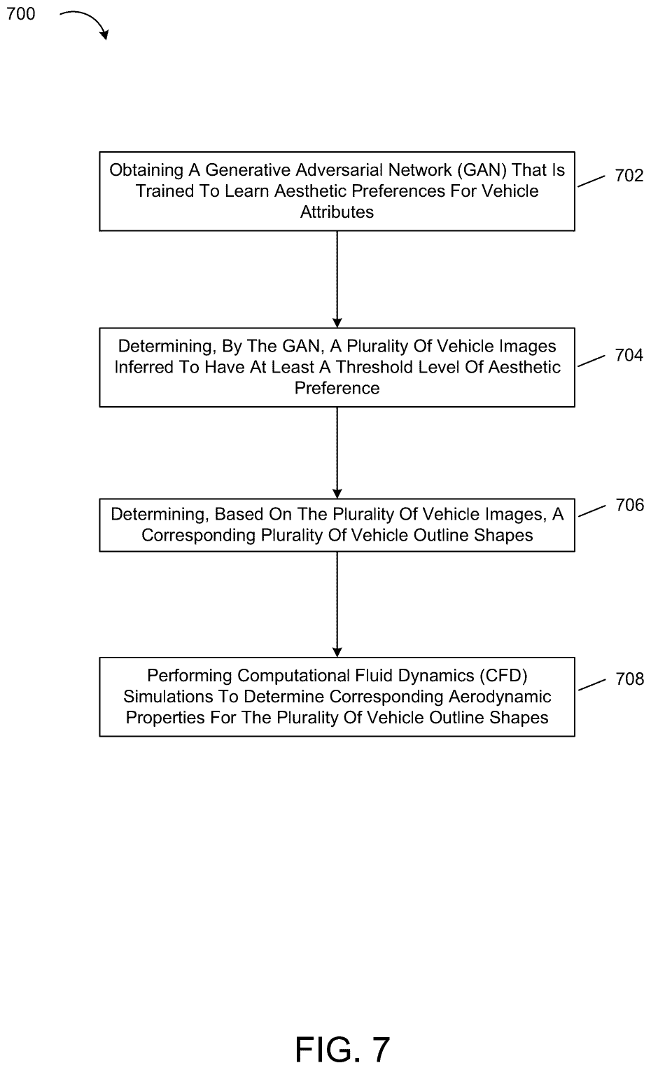

FIG. 7 shows an illustrative example of a process 700 for multidisciplinary vehicle design, in accordance with one or more example embodiments of the present disclosure. In at least one embodiment, some or all of the process 700 (or any other processes described herein, or variations and/or combinations thereof) is performed under the control of one or more computer systems that store computer-executable instructions and may be implemented as code (e.g., computer-executable instructions, one or more computer programs, or one or more applications) executing collectively on one or more processors, by hardware, software, or combinations thereof. The code, in at least one embodiment, is stored on a computer-readable storage medium in the form of a computer program comprising a plurality of computer-readable instructions executable by one or more processors. The computer-readable storage medium, in at least one embodiment, is a non-transitory computer-readable medium. In at least one embodiment, at least some of the computer-readable instructions usable to perform the process 700 are not stored solely using transitory signals (e.g., a propagating transient electric or electromagnetic transmission). A non-transitory computer-readable medium does not necessarily include non-transitory data storage circuitry (e.g., buffers, caches, and queues) within transceivers of transitory signals. Process 700 may be implemented in the context of various systems and methods described elsewhere in this disclosure, such as those discussed in connection with FIGS. 1-5. In at least one embodiment, process 700 or a portion thereof is collectively implemented by a computer system.

In various embodiments, process 700 comprises a step to obtain a generative adversarial network (GAN) that is trained to learn aesthetic preferences for vehicle attributes 702. In various embodiments, the GAN is further configured to receive a latent code as the input, in a first latent space,

determine, based on a non-linear mapping network, an intermediate vector, in a second latent space, and provide the intermediate vector as an input to one or more affine transformations of a synthesis network that synthesizes an image based on the aesthetic preferences. The non-linear mapping network may comprises 5-10 fully connected layers. The synthesis network may comprises 15-20 layers. The intermediate vector may be provided as an input to affine transformation of the synthesis network. Each layer of the synthesis network may be operable to receive per-channel scaling factors for Gaussian noise inputs.

In various embodiments, process 700 comprises a step to determine, by the GAN, a plurality of vehicle images inferred to have at least a threshold level of aesthetic preference 704. In various embodiments, process 700 comprises a step to determine, based on the plurality of vehicle images, a corresponding plurality of vehicle outline shapes 706. In various embodiments, process 700 comprises a step to perform computational fluid dynamics (CFD) simulations to determine corresponding aerodynamic properties for the plurality of vehicle outline shapes 708.

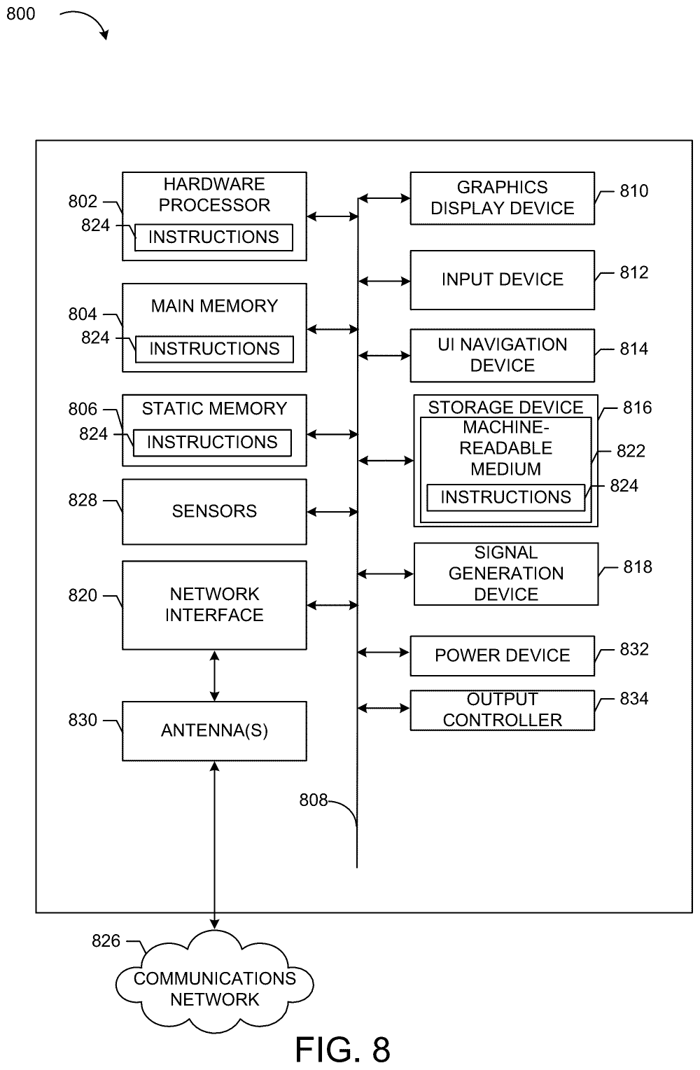

FIG. 8 illustrates a block diagram of an example of a machine 800 or system upon which any one or more of the techniques (e.g., methodologies) discussed herein may be performed. For example, machine 800 may be used to perform CFD simulations, perform GAN modeling and/or training, or a combination thereof. In some cases, the same machine is used to perform CFD-related functionality and GAN-related functionality. In some embodiments, multiple machines (e.g., each implemented according to FIG. 8) may be used to implement various aspects of systems and methods described herein. Various aspects of FIGS. 1-7 may be implemented using one or more machines described in connection with FIG. 8 In other embodiments, the machine 800 may operate as a standalone device or may be connected (e.g., networked) to other machines. In a networked deployment, the machine 800 may operate in the capacity of a server machine, a client machine, or both in server-client network environments. The machine 800 may be a wearable device or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 800 may include any combination of the illustrated components. For example, the machine 800 may include a hardware processor 802 (e.g., a central processing unit (CPU), a graphics processing unit (GPU), a tensor processing unit (TPU) including an artificial intelligence application-specific integrated circuit (ASIC), a hardware processor core, or any combination thereof), a main memory 804 and a static memory 806, some or all of which may communicate with each other via an interlink (e.g., bus) 808. The machine 800 may further include a power management device 832, a graphics display device 810, an alphanumeric input device 812 (e.g., a keyboard), and a user interface (UI) navigation device 814 (e.g., a mouse). In an example, the graphics display device 810, alphanumeric input device 812, and UI navigation device 814 may be a touch screen display. The machine 800 may additionally include a storage device (i.e., drive unit) 816, a signal generation device 818 (e.g., a data signal), a network interface device/transceiver 820 coupled to antenna(s) 830, and one or more sensors 828, such as a sound detecting sensor (e.g., a microphone), accelerometers, magnetometers, location sensors, and the like. The machine 800 may include an output controller 834, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, other sensors, etc.)).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within the static memory 806, or within the hardware processor 802 during execution thereof by the machine 800. In an example, one or any combination of the hardware processor 802, the main memory 804, the static memory 806, or the storage device 816 may constitute machine-readable media.

While the machine-readable medium 822 is illustrated as a single medium, the term “machine-readable medium” may include a single medium or multiple media (e.g., a centralized or distributed database, and/or associated caches and servers) configured to store the one or more instructions 824.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 800 and that cause the machine 800 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include DOCSIS, fiber optic, a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network 826. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cable box, a wearable smart device, cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a wearable smart device, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, DOCSIS, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Implementations of the systems, apparatuses, devices, and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general-purpose computer, special purpose computer, or special purpose processing device to perform a certain function or group of functions. An implementation of the devices, systems and methods disclosed herein may communicate over a computer network. A “network” is defined as one or more data links that enable the transport of electronic data between computer systems and/or modules and/or other electronic devices.

Although the subject matter has been described in language specific to structural features and/or methodological acts, it is to be understood that the subject matter defined in the appended claims may not necessarily be limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A system, comprising:
one or more processors; and
memory storing executable instructions that, as a result of execution by the one or more processors, cause the one or more processors to:
perform computational fluid dynamics (CFD) simulations to determine a set of vehicle outline shapes, wherein the CFD simulations are used to determine one or more aerodynamic properties of the set of vehicle outline shapes;
provide a first vehicle outline shape of the set of vehicle outline shapes as an input to a generative adversarial network (GAN) that is trained to learn aesthetic preferences for vehicle attributes;
determine, by the GAN and based on the vehicle outline shape, a set of vehicle attributes; and
generate, by the GAN and based at least in part on the input, an image of a vehicle, wherein the vehicle depicted in the image has an outline that corresponds to the vehicle outline shape and has the set of vehicle attributes.

2. The system of claim 1, wherein the set of vehicle attributes comprises at least: color, shape, and wheel design.

3. The system of claim 1, wherein the set of vehicle outline shapes are selected based on aerodynamic drag coefficient determined by the CFD simulations.

4. The system of claim 1, wherein the GAN is further configured to:
receive a latent code as the input, in a first latent space;
determine, based on a non-linear mapping network, an intermediate vector, in a second latent space; and
provide the intermediate vector as an input to one or more affine transformations of a synthesis network that synthesizes an image based on the aesthetic preferences.

5. The system of claim 4, wherein:
the non-linear mapping network comprises 5-10 fully connected layers; and
the synthesis network comprises 15-20 layers.

6. The system of claim 5, wherein each layer of the synthesis network comprises a Gaussian noise input.

7. The system of claim 1, wherein the system is further configured to:
determine, for each respective vehicle outline shape of the set of vehicle outline shapes, a respective performance score and a respective style score; and
determine a Pareto front based on the performance scores and the styles scores of the set of vehicle outline shapes.

8. A method, comprising:
performing computational fluid dynamics (CFD) simulations to determine a set of vehicle outline shapes, wherein the CFD simulations are used to determine one or more aerodynamic properties of the set of vehicle outline shapes;
providing a first vehicle outline shape of the set of vehicle outline shapes as an input to a generative adversarial network (GAN) that is trained to learn aesthetic preferences for vehicle attributes;
determining, by the GAN and based on the vehicle outline shape, a set of vehicle attributes; and
generating, by the GAN and based at least in part on the input, an image of a vehicle, wherein the vehicle depicted in the image has an outline that corresponds to the vehicle outline shape and has the set of vehicle attributes.

9. The method of claim 8, wherein the set of vehicle attributes comprises at least: color, shape, and wheel design.

10. The method of claim 8, wherein the set of vehicle outline shapes are selected based on aerodynamic drag coefficient determined by the CFD simulations.

11. The method of claim 8, wherein the GAN is further configured to:
receive a latent code as the input, in a first latent space;
determine, based on a non-linear mapping network, an intermediate vector, in a second latent space; and
provide the intermediate vector as an input to one or more affine transformations of a synthesis network that synthesizes an image based on the aesthetic preferences.

12. The method of claim 11, wherein:
the non-linear mapping network comprises 5-10 fully connected layers; and
the synthesis network comprises 15-20 layers.

13. The method of claim 12, wherein the intermediate vector is provided as an input to affine transformation of the synthesis network.

14. The method of claim 11, wherein each layer of the synthesis network comprises a Gaussian noise input.

15. The method of claim 8, further comprising:
determining, for each respective vehicle outline shape of the set of vehicle outline shapes, a respective performance score and a respective style score; and
determining a Pareto front based on the performance scores and the styles scores of the set of vehicle outline shapes.

16. A method, comprising:
obtaining a generative adversarial network (GAN) that is trained to learn aesthetic preferences for vehicle attributes;
determining, by the GAN, a plurality of vehicle images inferred to have at least a threshold level of aesthetic preference;
determining, based on the plurality of vehicle images, a corresponding plurality of vehicle outline shapes; and
performing computational fluid dynamics (CFD) simulations to determine corresponding aerodynamic properties for the plurality of vehicle outline shapes.

17. The method of claim 8, wherein the GAN is further configured to:
receive a latent code as the input, in a first latent space;
determine, based on a non-linear mapping network, an intermediate vector, in a second latent space; and
provide the intermediate vector as an input to one or more affine transformations of a synthesis network that synthesizes an image based on the aesthetic preferences.

18. The method of claim 17, wherein:
the non-linear mapping network comprises 5-10 fully connected layers; and
the synthesis network comprises 15-20 layers.

19. The method of claim 18, wherein the intermediate vector is provided as an input to affine transformation of the synthesis network.

20. The method of claim 17, wherein each layer of the synthesis network comprises a Gaussian noise input.
